(19) United States
(12) Patent Application Publication
(10) Pub. No.: US 2008/0273025 A1
(43) Pub. Date: Nov. 6, 2008

(54) Plasma display and driving method thereof

(76) Inventors: Jin-Ho YANG, Suwon-si (KR); Nam-Sung Jung, Suwon-si (KR)

Correspondence Address: ROBERT E. BUSHNELL, 1522 K STREET NW, SUITE 300, WASHINGTON, DC, 20005-1202, US

(21) Appl. No.: 12/081,939

(22) Filed: Apr. 23, 2008

(30) Foreign Application Priority Data
May 3, 2007 (KR) 10-2007-0043136

(51) Int. Cl. G06F 3/038; G09G 3/28

(52) U.S. Cl. 345/211; 345/60

(57) ABSTRACT

In a plasma display device, a first transistor is coupled between an electrode and a power source supplying a VscL voltage, and a second transistor gradually changing a voltage of the electrode is coupled between the electrode and the power source. First and second resistors are coupled in series between the electrode and the second transistor. A node of the first and second resistors is coupled to a control terminal of a regulator, an anode terminal of the regulator is coupled to the electrode, and a cathode terminal of the regulator is coupled to the second transistor. The regulator has a reference voltage, and connects the anode terminal and the cathode terminal when the second transistor is turned on and a node voltage of a node between the first and second resistors is greater than the reference voltage and disconnects the anode terminal and the cathode terminal when the node voltage is less than the reference voltage. That is, a voltage of the electrode can be decreased to a Vnf voltage that is greater than a VscL voltage by repeatedly connecting and disconnecting the anode terminal and the cathode terminal of the regulator. In this way, voltages of two levels can be supplied from one power source.

### CLAIM OF PRIORITY

This application makes reference to, incorporates the same herein, and claims all benefits accruing under 35 U.S.C. §119 from an application for PLASMA DISPLAY AND DRIVING METHOD THEREOF earlier filed in the Korean Intellectual Property Office on the 3^{rd} of May 2007 and there duly assigned Serial No. 10-2007-0043136.

### BACKGROUND OF THE INVENTION

1. Field of the Invention

The present invention relates to a plasma display device and a driving method thereof.

2. Description of the Related Art

A plasma display includes a Plasma Display Panel (PDP) that uses a plasma generated by a gas discharge to display characters or images. In the PDP, a plurality of discharge cells are arranged in a matrix format.

In general, the plasma display is driven by dividing one field into a plurality of subfields, and grayscales are displayed by a combination of weight values of subfields among the plurality of subfields, in which a display operation is performed. Light emitting cells and non-light emitting cells are selected by an address discharge during an address period of each subfield, and an image is actually displayed by a sustain discharge performed for the light emitting cells during a sustain period.

Such a discharge occurs only when a voltage difference between two electrodes is set higher than a predetermined voltage, the level of a voltage used for each electrode in the address period and sustain period being different, and accordingly the number of power sources supplying each voltage is increased.

### SUMMARY OF THE INVENTION

The present invention has been made in an effort to provide a plasma display device having a reduced number of power sources.

An exemplary plasma display device according to one embodiment of the present invention includes an electrode, a first transistor, a second transistor, first and second resistors, and voltage reference circuit. The first transistor is coupled between the electrode and a power source that supplies a first voltage. The second transistor is coupled between the electrode and the power source and operates to gradually change a voltage of the electrode. The first and second transistors are coupled in series either between the electrode and the second transistor or between the power source and the second transistor. The voltage reference circuit supplies a reference voltage when the second transistor is turned on, and allows a current to flow through a second path that is different from a first path formed by the first and second resistors between the electrode and the power source when a node voltage of a node between the first and second resistors is greater then the reference voltage.

An exemplary plasma display device according to another embodiment of the present invention includes a plurality of electrodes, a first transistor, a second transistor, first and second resistors, a comparator, and a third transistor. The first transistor is coupled between the plurality of electrodes and a power source that supplies a first voltage. The second transistor is coupled to the plurality of electrodes and the power source, and operates to gradually change a voltage of the electrodes. The first and second resistors are coupled in series on a first path formed between the electrodes and the power source when the second transistor is turned on. The comparator compares a node voltage of a node between the first and second resistors with a reference voltage, and determines an output voltage corresponding to the comparison result. The third transistor is turned on responding to the determined output voltage, and allows a current to flow through a second path formed between the electrodes and the power source.

An exemplary plasma display device according to another embodiment of the present invention includes a plurality of electrodes, a first transistor, a second transistor, first and second resistors, and a regulator. The first transistor is coupled between the plurality of electrodes and a power source that supplies a first voltage. The second transistor is coupled between the plurality of electrodes and the power source, and operates to gradually change a voltage of the electrodes. The first and second resistors are coupled in series on a first path formed between the electrodes and the power source when the second transistor is turned on. The regulator has first to third terminals and allows a current to flow through a second path formed by the second and third terminals between the electrodes and the power source when the second transistor is turned on and a node voltage of a node between the first and second resistors is greater than a reference voltage. The first terminal of the regulator is coupled to the node between the first and second resistors.

An exemplary method according to another embodiment of the present invention drives a plasma display device having an electrode. The method includes changing a voltage of the electrode to a second voltage by turning on a first transistor coupled between the electrode and a power source that supplies a first voltage, and supplying the first voltage to the electrode by turning on a second transistor coupled between the electrode and the power source. The changing of the voltage of the electrode to the second voltage includes allowing a current to flow through a first path formed by a first resistor and a second resistor coupled in series between the electrode and the power source, and allowing a current to flow through a second path that is different from the first path when a node voltage of a node between the first and second resistors is greater than a reference voltage.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a view of a plasma display device according to an exemplary embodiment of the present invention.

FIG. 2 are views of driving waveforms of the plasma display device according to the exemplary embodiment of the present invention.

FIG. 3 is a circuit diagram of a scan electrode driver according to the exemplary embodiment of the present invention.

FIG. 4 to FIG. 7 are respective circuit diagrams of a voltage generator according to first to fourth exemplary embodiments of the present invention.

### DETAILED DESCRIPTION OF THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification. When it is described that an element is connected to another element, the element may be directly connected to the other element or connected to the other element through a third element.

Throughout the specification and the claims that follow, an expression of sustaining voltage includes a case where although a potential difference between two specific points changes with the passage of time, the change is within a range allowable in designing or caused by a parasitic component that is disregarded in the usual practice in designing by a person skilled in the art. In addition, compared with a discharge voltage, a threshold voltage of a semiconductor element (transistor or diode, etc.) is very low, so the threshold voltage is regarded as 0 V. Thus, voltages supplied to a node or an electrode by a power source includes voltages changed due to a threshold voltage or a parasitic component, etc., from voltage of the power source voltage.

A plasma display device and a driving method thereof according to an exemplary embodiment of the present invention is described in further detail below with respect to the accompanying drawings.

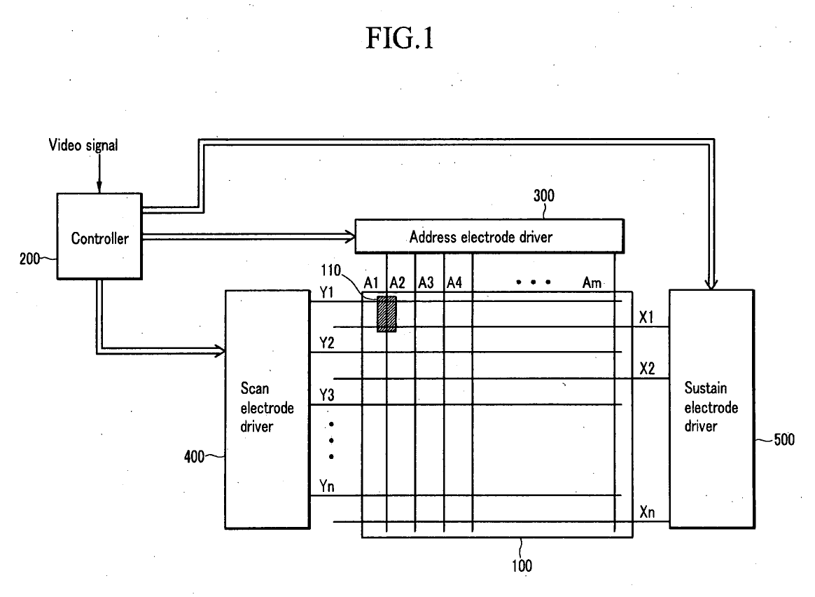

FIG. 1 is a view of a plasma display device according to the exemplary embodiment of the present invention.

As shown in FIG. 1, the plasma display device includes a PDP 100, a controller 200, an address electrode driver 300, a scan electrode driver 400, and a sustain electrode driver 500.

The PDP 100 includes a plurality of address electrodes A1 to Am (hereinafter referred to as “A electrodes”) extending in a column direction, and a plurality of sustain electrodes X1 to Xn (hereinafter referred to as “X electrodes”) and scan electrodes Y1 to Yn (hereinafter referred to as “Y electrodes”) extending in a row direction by pairs. The X electrodes X1 to Xn are formed in correspondence to the Y electrodes Y1 to Yn, and a display operation is performed by the X and Y electrodes in the sustain period. The Y electrodes Y1 to Yn and the X electrodes X1 to Xn intersect the A electrodes A1 to Am. The Y and X electrodes Y1 to Yn and X1 to Xn are arranged perpendicular to the A electrodes A1 to Am. This structure of the PDP 100 is merely exemplary, and panels of other structures can be used in the present invention as well.

The controller 200 receives an external video signal, and outputs an A electrode driving control signal, an X electrode driving control signal, and a Y electrode driving control signal. In addition, the controller 200 drives the plasma display device by dividing one frame into a plurality of subfields. Each subfield includes a reset period, an address period, and a sustain period.

The address electrode driver 300 receives the A electrode driving control signal from the controller 200, and supplies a display data signal for selecting a discharge cell to be discharged to each of the A electrodes.

The scan electrode driver 400 receives the Y electrode driving control signal from the controller 200, and supplies a driving voltage to the Y electrode.

The sustain electrode driver 500 receives the X electrode driving control signal from the controller 200, and supplies a driving voltage to the X electrode.

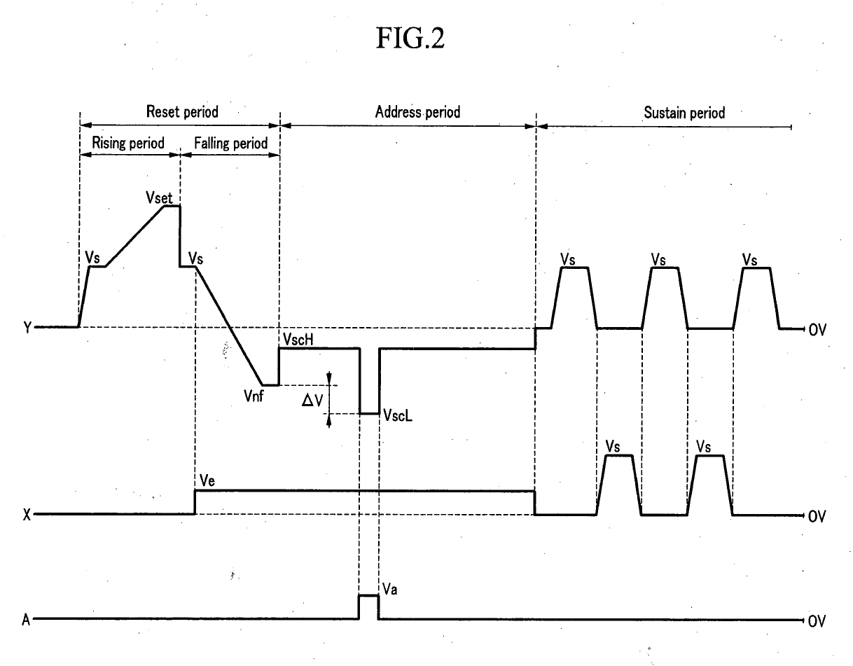

FIG. 2 are views of driving waveforms of the plasma display device according to the exemplary embodiment of the present invention. For better understanding and ease of description, a description follows for a driving waveform of one subfield among the plurality of subfields, the driving waveform being supplied to one cell formed of a Y electrode, an X electrode, and an A electrode.

As shown in FIG. 2, in a rising period of the reset period, the address electrode driver 300 and the sustain electrode driver 500 respectively bias the A electrode A and the X electrode X with a reference voltage (0 V in FIG. 2), and the scan electrode driver 400 gradually increases a voltage of the Y electrode Y from a Vs voltage to a Vset voltage. In FIG. 2, the voltage of the Y electrode Y is increased in a ramp pattern. As the voltage of the Y electrode Y is increased, a weak discharge is generated between the Y electrode Y and the X electrode X and between the Y electrode Y and the A electrode A so that negative (−) wall charges are formed on the Y electrode Y and positive (+) wall charges are formed on the X and A electrodes X and A.

In a falling period of the reset period, the sustain electrode driver 500 biases the X electrode X with a Ve voltage, and the scan electrode driver 400 gradually decreases the voltage of the Y electrode Y from the Vs voltage to a Vnf voltage. In FIG. 2, the voltage of the Y electrode Y is increased in a ramp pattern. As the voltage of the Y electrode Y is decreased, a weak discharge is generated between the Y electrode Y and the X electrode X and between the Y electrode Y and the A electrode A so that the (−) wall charges formed on the Y electrode Y and the (−) wall charges formed on the X and A electrodes X and A are erased. In general, a (Vnf-Ve) voltage is set to be close to a discharge firing voltage between the Y electrode Y and the X electrode X. Then, a wall voltage between the Y electrode Y and the X electrode X reaches near 0 V, and therefore a cell that was not addressed with an address discharge during the address period is prevented from misfiring during the sustain period.

Generally, when the Vnf voltage is supplied in the reset period, a sum of a wall voltage between the A electrode A and the Y electrode Y and an external voltage (i.e., Vnf voltage) is determined by a discharge firing voltage between the A electrode A and the Y electrode Y. When 0 V is supplied to the A electrode A and the VscL voltage (that corresponds to the Vnf voltage) is supplied to the Y electrode Y in the address period, the discharge firing voltage is generated between the A electrode A and the Y electrode Y, and accordingly, a discharge is expected. However, in this case, the expected discharge does not occur because a discharge delay is greater than the width of scan and address pulses. However, if a Va voltage is supplied to the A electrode A and the VscL voltage (=Vnf voltage) is supplied to the Y electrode Y, a voltage that is greater than the discharge firing voltage is formed between the A electrode A and the Y electrode Y so that the discharge delay is reduced to less than the width of the scan pulse, thereby allowing a discharge to occur. In this case, when the VscL voltage is set to be lower than the Vnf voltage, a voltage difference (VscL−Va) between the Y electrode Y and the A electrode A is increased so that the address discharge can be efficiently generated. In addition, the voltage Va can be lowered as much as the voltage difference (VscL−Vnf). Hereinafter, the voltage difference (VscL−Vnf) will be referred to as ΔV. Thus, the VscL voltage level is set to be equal to or less than the Vnf voltage level, and the Va voltage level is set to be greater than the reference voltage during the address period. In FIG. 2, the VscL voltage is set to be less than the Vnf voltage by the ΔV voltage.

During the sustain period, the scan electrode driver 400 supplies a sustain pulse alternately having a high level voltage (Vs voltage in FIG. 2) and a low level voltage (0 V in FIG. 2) to the plurality of plurality of Y electrodes a number of time corresponding to a weight value of the corresponding subfield. The sustain electrode driver 500 supplies the sustain pulse having a reverse phase to the sustain pulse supplied to the Y electrodes Y, to the plurality of X electrodes X. Accordingly, a voltage difference between each of the Y electrodes Y and each of the X electrodes X alternately becomes the Vs voltage and a −Vs voltage, and the sustain discharge is repeatedly generated on an address-discharged cell (i.e., a light emitting cell) a predetermined number of times.

Although FIG. 2 illustrates a sustain pulse having the Vs voltage and the 0 V voltage being alternately supplied to the Y electrode Y and the X electrode X, a sustain pulse alternately having the Vs voltage and the −Vs voltage may be supplied to the Y electrode X and/or the X electrode X so that a voltage difference of the Y electrode Y and the X electrode X alternately becomes the Vs voltage and the −Vs voltage. For example, the sustain pulse alternately having the Vs voltage and the −Vs voltage may be supplied to the Y electrode Y while the X electrode X is biased to a ground voltage.

Furthermore, in FIG. 2, after a cell is initialized to a non-light emitting cell by erasing a wall charge of a cell in a reset period, the cell is set to be a light emitting cell through an address discharge in an address period, but after the cell is set to be the light emitting cell or after a sustain period of a previous subfield by writing a wall charge in the cell in a reset period, the cell may be set to be a non-light emitting cell through an address discharge in an address period.

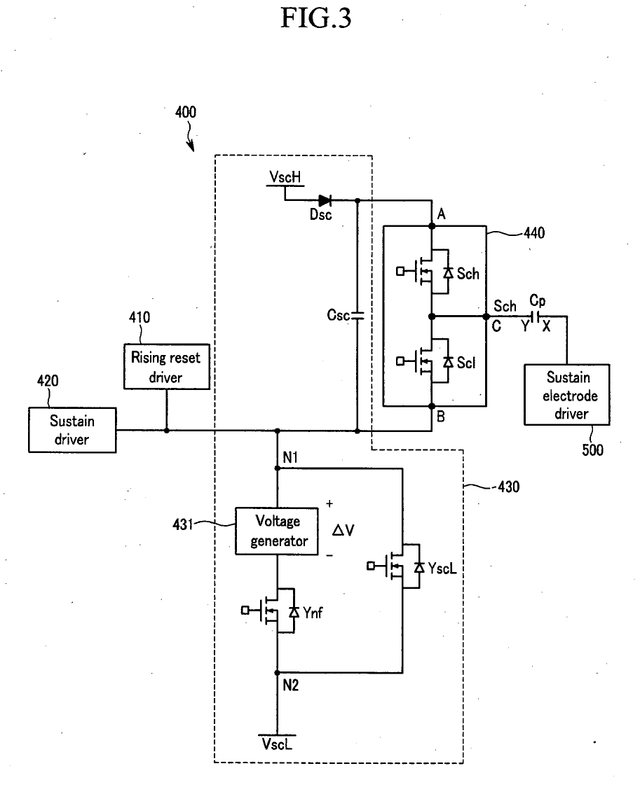

A driving circuit that can implement voltage of difference levels by one power source is described below in further detail with reference to FIG. 3. In FIG. 3, the driving circuit implements the Vnf voltage and the VscL voltage with one power supply.

FIG. 3 is a circuit diagram of a scan electrode driver according to the exemplary embodiment of the present invention. For convenience of explanation, only one Y electrode Y and one X electrode X have been illustrated in FIG. 3, and a capacitive component formed by one Y electrode Y and one X electrode X is illustrated as a panel capacitor Cp.

As shown in FIG. 3, the scan electrode driver 400 according to the exemplary embodiment of the present invention includes a rising reset driver 410, a sustain driver 420, a falling reset/scan driver 430, and a scan circuit 440. In FIG. 3, transistors Ynf, YscL, Sch, and Scl are n-channel field effect transistors, particularly, N-channel Metal Oxide Semiconductors (NMOS), and a body diode is formed in a source to a drain direction of each of the transistors Ynf, YscL, Sch, and Scl. Other transistors having similar functions to the transistors Ynf, YscL, Sch, and Scl can replace the NMOS transistors. In addition, although the transistors Ynf, YscL, Sch, and Scl in FIG. 3 are individually shown, the transistors Ynf, YscL, Sch, and Scl may each be formed of a plurality of transistors coupled in parallel.

The scan circuit 440 includes the transistors Sch and Scl, a first input terminal A, a second input terminal B, and an output terminal C that is coupled to the Y electrode Y. A source of the transistor Sch and a drain of the transistor Scl are coupled to the output terminal C, a drain of the transistor Sch is coupled to the first input terminal A, and a power source VscH that supplies a VscH voltage to the first input terminal A is coupled to the first input terminal A. A source of the transistor Scl is coupled to the second input terminal B. The scan circuit 440 selectively supplies a voltage of the first input terminal A and a voltage of the second input terminal B to the corresponding Y electrode so as to select light emitting cells in the address period.

Although one scan circuit 440 is illustrated in FIG. 3 as being coupled to the Y electrode Y, a plurality of Y electrodes Y1 to Yn may each be coupled to respective scan circuits 440. According to another exemplary embodiment of the present invention, a predetermined number of scan circuits 440 are formed in one scan Integrated Circuit (IC) so that a plurality of output terminals of the scan IC can be respectively coupled to a predetermined number of Y electrodes. Herein, the predetermined number of Y electrodes is set to Y1 to Yk (where k is less than n).

The falling reset/scan driver 430 includes the transistors Ynf and YscL, a voltage generator 431, a capacitor Csc, and a diode Dsc.

An anode of the diode Dsc is coupled to the power source VscH and a cathode of the diode Dsc is coupled to the second input terminal B, and the capacitor Csc is coupled between the first input terminal A and the second input terminal B. Drains of the transistors YscL and Ynf are respectively coupled to a node N1, and sources of the transistors YscL and Ynf are respectively coupled to a node N2. The second input terminal B of the scan circuit 440 is coupled to the node N1, and a power source VscL that supplies the VscL voltage is coupled to the node N2. The voltage generator 431 is coupled between the node N1 and the drain of the transistor Ynf, and generates a ΔV voltage. The voltage generator 431 may be coupled between the source of the transistor Ynf and the node N2.

Therefore, when the transistor Vnf is turned on in the falling period of the reset period, the voltage of the Y electrode Y can be reduced to the Vnf (=VscL+ΔV) voltage. In this case, when the transistor Ynf is turned on, the transistor Ynf causes a minute current to flow from the drain to the source so as to gradually decrease the voltage of the Y electrode Y to the Vnf voltage. The transistor YscL is turned on in the address period, and supplies the VscL voltage to the second input terminal B of the scan circuit 440.

The sustain driver 420 is coupled to the second input terminal B of the scan circuit 440 and supplies a sustain pulse alternately having the Vs voltage and the 0 V voltage to the plurality of Y electrodes Y through the second input terminal B of the scan circuit 440 during the sustain period. The rising reset driver 410 is coupled to the second input terminal B of the scan circuit 440 and supplies a rising reset waveform to the Y electrode through the second input terminal B of the scan circuit 440 during the rising period of the reset period.

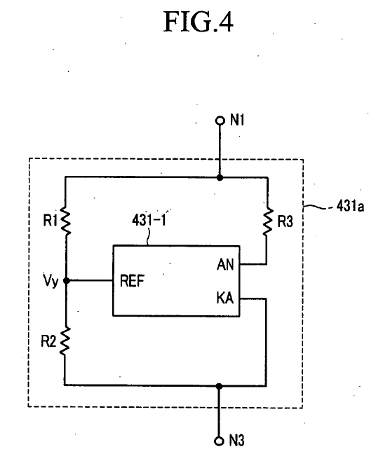

The voltage generator 431 of FIG. 3 is described in further detail below with reference to FIG. 4 to FIG. 7. In FIG. 4 to FIG. 7, the source of the transistor YscL is denoted as a node N3.

FIG. 4 is a circuit diagram of a voltage generator 431a according to a first exemplary embodiment of the present invention.

As shown in FIG. 4, the voltage generator 431a includes a regulator 431-1 and resistors R1, R2, and R3. The resistors R1 and R2 are coupled in series between the node N1 and the node N3, an anode terminal AN of the regulator 431-1 is coupled to the node N1, a cathode terminal KA of the regulator 431-1 is coupled to the node N3, and a reference terminal REF of the regulator 431-1 is coupled to a node between the resistors R1 and R2. The resistor R3 may be coupled between the anode terminal AN of the regulator 431-1 and the node N1. The regulator 431-1 connects the anode terminal AN and the cathode terminal KA when a voltage divided by the resistors R1 and R2 becomes greater than a Vref voltage. The regulator 431-1 has a reference voltage Vref, and operates as voltage reference circuit using the reference voltage Vref as a comparison value.

When the transistor Ynf is turned on in the falling period of the reset period, a small amount of current flows due to the resistors R1 and R2. If a current flowing to the resistor R2 is denoted as I₁, a Vy voltage can be obtained by Equation 1 below.

Vy=I₁R₂ Equation 1

When the current I₁ increases as time passes, the Vy voltage also increases. In this case, when the Vy voltage becomes greater than the Vref voltage, the anode terminal AN and the cathode terminal KA of the regulator 431-1 are connected. Since the size of the resistor R3 is very small, a current flows through the Y electrode Y, the regulator 431-1, the transistor Ynf, and the power source VscL so that the voltage of the Y electrode Y is decreased and the current I₁ is reduced.

When the current I₁ is reduced, the Vy voltage becomes less than the Vref voltage, and the anode terminal AN and the cathode terminal KA of the regulator 431-1 are disconnected so that the current flows through the Y electrode Y, the resistors R1 and R2, the transistor Ynf, and the power VscL, and the Vy voltage is increased again. When the Vy voltage becomes greater than the Vref voltage, the anode terminal AN and the cathode terminal KA of the regulator 431-1 are connected again.

As described, the voltage of the Y electrode is gradually decreased as the anode terminal AN and the cathode terminal KA of the regulator 431-1 are repeatedly connected and disconnected. When the voltage of the Y electrode Y is gradually decreased and becomes equal to the Vnf voltage, the Vy voltage cannot be greater than the Vref voltage, and therefore the anode terminal AN and the cathode terminal KA of the regulator 431-1 are not connected. In this case, since the resistors R1 and R2 have large resistance values, the voltage of the Y electrode Y can be substantially maintained at the Vnf voltage level for a predetermined time period.

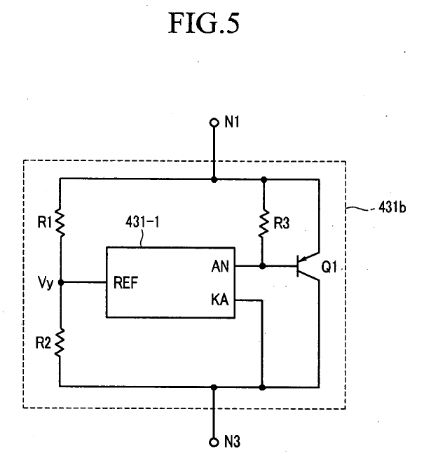

FIG. 5 is a circuit diagram of a voltage generator 431b according to a second exemplary embodiment of the present invention.

As shown in FIG. 5, constituent elements of the voltage generator 431b according to the second exemplary embodiment of the present invention are the same as those of the voltage generator 431a, except for a transistor Q1. The transistor Q1 is shown as a Bipolar Junction Transistor (BJT) in FIG. 5, but can be replaced with another type of transistor. An emitter of the transistor Q1 is coupled to a node N1, a collector of the transistor Q1 is coupled to a drain of a transistor YscL, and a base of the transistor Q1 is coupled to the anode terminal An of the regulator 431-1. The base is a control terminal of the transistor Q1.

In such a voltage generator 431b, when the anode terminal AN and the cathode terminal KA of the regulator 431-1 are connected and a base-emitter voltage |Vbe| of the transistor Q1 becomes less than a threshold voltage Vth, the transistor Q1 is turned on. Then, a current flows through the Y electrode Y, the transistor Q1, the transistor Ynf, and the power source VscL. When the current I₁ is reduced, the Vy voltage becomes less than the Vref voltage, and the anode terminal AN and the cathode terminal KA of the regulator 431-1 are disconnected and the base of the transistor Q1 cannot be supplied with a voltage so that the transistor Q1 is turned off. Then, a current flows through the Y electrode Y, the resistors R1 and R2, the transistor Ynf, and the power source VscL so that the Vy voltage is increased again.

When the Vy voltage becomes greater than the Vref voltage, the anode terminal AN and the cathode terminal KA of the regulator 431-1 are connected again. As the above-described process is repeated, the voltage of the Y electrode Y is decreased to the Vnf voltage. The regulator 431-1 cannot supply a large amount of current due to a limited current capacity. Therefore, the current capacity can be increased by using the transistor Q1.

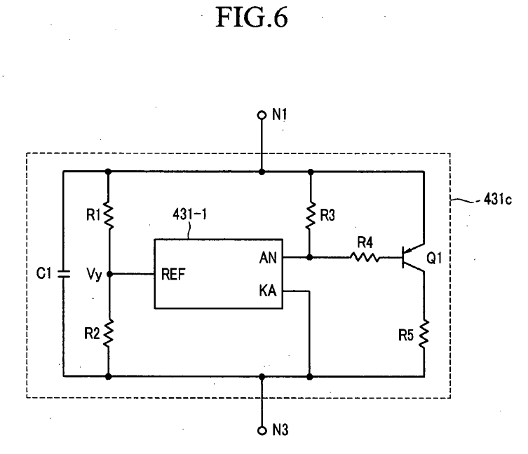

FIG. 6 is a circuit diagram of a voltage generator 431c according to a third exemplary embodiment of the present invention.

As shown in FIG. 6, constituent elements of the voltage generator 431c according to the third exemplary embodiment of the present invention are the same as those of the voltage generator 431b, except for a capacitor C1 and resistors R4 and R5. The capacitor C1 is coupled between the node N1 and the transistor YscL. The resistor R4 is coupled between the anode terminal AN of the regulator 431-1 and the base of the transistor Q1, and the resistor R5 is coupled between the collector of the transistor Q1 and the node N3. The voltage generator 431c operates the same as the voltage generator 431b of FIG. 5. In this case, the capacitor C1 regulates a voltage between the node N1 and the drain of the transistor YscL, and the resistors R4 and R5 protect the transistor Q1.

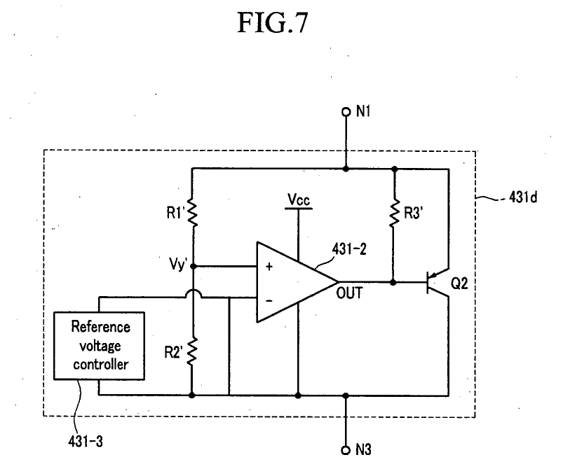

According to the first to third exemplary embodiments of the present invention, the reference voltage Vref is input to the regulator 431-1 so that the reference voltage Vref cannot be changed. In the following exemplary embodiment of the present invention, a method for changing the ΔV voltage while changing the reference voltage according to an exemplary embodiment of the present invention is described in further detail below with reference to FIG. 7.

FIG. 7 is a circuit diagram of a voltage generator 431d according to a fourth exemplary embodiment of the present invention.

As shown in FIG. 7, the voltage generator 431d according to the fourth exemplary embodiment of the present invention includes a comparator 431-2, a reference voltage controller 431-3, a transistor Q2, and resistors R1′, R2′, and R3′. The resistors R1′ and R2′ are coupled in series between the node N1 and the drain of the transistor YscL. A non-inverting terminal (+) of the comparator 431-2 is coupled to a node of the resistors R1′ and R2′, and an inverting terminal (−) of the comparator 431-2 is coupled to the reference voltage controller 431-3. An output terminal OUT of the comparator 431-2 is coupled to a base of the transistor Q2, an emitter of the transistor Q2 is coupled to the node N1, and a collector of the transistor Q2 is coupled to the drain of the transistor YscL. The resistor R3′ is coupled between the base of the transistor Q2 and the node N1. The reference voltage controller 431-3 inputs an externally received reference voltage Vref to the inverting terminal (−) of the comparator 431-2. The voltage generator 431d operates almost the same as the voltage generator 431a of FIG. 4. That is, the comparator 431-2 and the transistor Q2 perform the same functions as the regulators 431-1 of FIG. 4 to FIG. 6. That is, the comparator 431-2 and the transistor Q2 also operate as a voltage reference circuit.

When the transistor Ynf is turned on in the falling period of the reset period, the comparator 431-2 outputs a Vcc voltage when a voltage divided by the resistors R1′ and R2′, that is, a Vy′ voltage, becomes greater than a predetermined reference voltage Vref. In this case, the transistor Q2 is turned on when a base-emitter voltage |Vbe| of the transistor Q1 becomes less than the threshold voltage Vth. Then, a current flows through the Y electrode Y, the transistor Q2, the transistor Ynf, and the power source VscL. Therefore, the current I₁ is reduced and accordingly the Vy′ voltage becomes less than the Vref voltage again, and the Vy′ voltage is decreased. The comparator 431-2 outputs the VscL voltage when the Vy′ voltage is less than the predetermined reference voltage Vref. Then, the base-emitter voltage |Vbe| of the transistor Q2 becomes greater than the threshold voltage Vth so that the transistor Q2 is turned off.

When the transistor Q2 is turned off, a current flows through the Y electrode Y, the resistors R1′ and R2′, the transistor Ynf, and the power source VscL so that the Vy′ voltage is increased again. When the Vy′ voltage is increased to greater than the Vref voltage, the comparator 431-2 outputs the Vcc voltage to the base of the transistor Q2, and the transistor Q2 is turned on again when the base-emitter voltage |Vbe| of the transistor Q1 becomes less than the threshold voltage Vth. As described, the voltage of the Y electrode is decreased to the Vnf voltage as the transistor Q2 is repeatedly turned on and turned off.

The reference voltage controller 431-3 can change the reference voltage Vref input to the inverting terminal (−) of the comparator 431-2. That is, the Vnf voltage can be controlled in accordance with the reference voltage Vref.

As described above, different levels of voltages can be supplied from one power source, thereby reducing the number of power sources of the plasma display device according to the exemplary embodiments of the present invention.

While this invention has been described in connection with what is presently considered to be practical exemplary embodiments, it is to be understood that the present invention is not limited to the disclosed embodiments, but, on the contrary, is intended to cover various modifications and equivalent arrangements included within the spirit and scope of the appended claims.

What is claimed is:

1. A plasma display device comprising:
an electrode;
a first transistor coupled between the electrode and a power source supplying a first voltage;
a second transistor coupled between the electrode and the power source, the second transistor gradually changing a voltage of the electrode;
a first resistor and a second resistor coupled in series either between the electrode and the second transistor or between the power source and the second transistor; and
a voltage reference circuit to supply a reference voltage in response to the second transistor being turned on, and to allow a current to flow through a second path different from a first path constituted by the first and second resistors between the electrode and the power source in response to a node voltage of a node between the first and second resistors being greater than the reference voltage.

2. The plasma display device of claim 1, wherein the voltage reference circuit comprises a regulator having a reference terminal coupled to the node between the first and second resistors, a first terminal coupled to the electrode, and a second terminal coupled to the second transistor, and wherein the second path is constituted by the first and second terminals.

3. The plasma display device of claim 1, wherein the voltage reference circuit comprises a regulator having a reference terminal coupled to a node between the first and second resistors, a first terminal coupled to the second transistor, and a second terminal coupled to the power source, and wherein the second path is constituted by the first and second terminals.

4. The plasma display device of claim 2, further comprising a third transistor having a control terminal coupled to the first terminal of the regulator, the third transistor allowing a current to flow through a third path different from the second path between the electrode and the power source.

5. The plasma display device of claim 3, further comprising a third transistor having a control terminal coupled to the first terminal of the regulator, the third transistor allowing a current to flow through a third path different from the second path between the electrode and the power source.

6. The plasma display device of claim 1, further comprising a reference voltage controller to change the reference voltage.

7. The plasma display device of claim 6, wherein the voltage reference circuit comprises:
a comparator having a first terminal coupled to a node between the first and second resistors and a second terminal coupled to the reference voltage controller, the comparator determining an output voltage corresponding to the node voltage; and
a third transistor having a control end coupled to an output terminal of the comparator, the third transistor allowing a current to flow through the second path in response to the third transistor being turned on.

8. A plasma display device comprising:
a plurality of electrodes;
a first transistor coupled between the plurality of electrodes and a power source supplying a first voltage;
a second transistor coupled to the plurality of electrodes and the power source, the second transistor gradually changing a voltage of the plurality of electrodes;
a first resistor and a second resistor coupled in series on a first path between the plurality of electrodes and the power source in response to the second transistor being turned on;
a comparator to compare a node voltage of a node between the first and second resistors with a reference voltage, and to determine an output voltage corresponding to the comparison result; and
a third transistor turned on in response to the determined output voltage, the third transistor allowing a current to flow through a second path between the plurality of electrodes and the power source.

9. The plasma display device of claim 8, further comprising a reference voltage controller to change the reference voltage.

10. The plasma display device of claim 9, wherein the first transistor is turned on in an address period and the second transistor is turned on in a reset period, and wherein a voltage supplied to the plurality of electrodes in the reset period is greater than the first voltage.

11. A plasma display device comprising:
a plurality of electrodes;
a first transistor coupled between the plurality of electrodes and a power source supplying a first voltage;
a second transistor coupled between the plurality of electrodes and the power source, the second transistor gradually changing a voltage of the plurality of electrodes;
a first resistor and a second resistor coupled in series on a first path between the plurality of electrodes and the power source in response to the second transistor being turned on; and
a regulator having first to third terminals, the first terminal coupled to a node between the first and second resistors, the regulator allowing a current to flow through a second path constituted by the second and third terminals between the plurality of electrodes and the power source in response to the second transistor being turned on and a node voltage of the node between first and second resistors being greater than a reference voltage.

12. The plasma display apparatus of claim 11, wherein the first and second resistors are coupled in series between the plurality of electrodes and the second transistor, the second terminal coupled to the plurality of electrodes, and the third terminal coupled to the second transistor.

13. The plasma display device of claim 11, wherein the first and second resistors are coupled in series between the second transistor and the power source, the second terminal coupled to the second transistor, and the third terminal coupled to the power source.

14. The plasma display device of claim 11, further comprising a third transistor having a control terminal coupled to the second terminal of the regulator, the third transistor allowing a current to flow through a third path different from the second path between the plurality of electrodes and the power source in response to the second transistor being turned on.

15. A method of driving a plasma display device having an electrode, the method comprising:
changing a voltage of the electrode to a second voltage by turning on a first transistor coupled between the electrode and a power source supplying a first voltage; and
supplying the first voltage to the electrode by turning on a second transistor coupled between the electrode and the power source;
wherein changing the voltage of the electrode comprises:
allowing a current to flow through a first path constituted by a first resistor and a second resistor coupled in series between the electrode and the power source; and
allowing a current to flow through a second path different from the first path in response to a node voltage of a node between the first and second resistors being greater than a reference voltage.

16. The method of claim 15, wherein the second voltage is greater than the first voltage.

17. The method of claim 16, further comprising maintaining the voltage of the electrode at a second voltage level after changing the voltage of the electrode to the second voltage.
